(19) United States
(12) Patent Application Publication
(10) Pub. No.: US 2006/0255253 A1
(43) Pub. Date: Nov. 16, 2006

(54) Method for packaging an image sensor die and a package thereof

(76) Inventors: Wei-Min Hsiao, Kaoshiung (TW); Kuo-Pin Yang, Kaoshiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/287,269

(22) Filed: Nov. 28, 2005

(30) Foreign Application Priority Data
May 13, 2005 (TW) 94115712

(51) Int. Cl. H01J 5/02

(52) U.S. Cl. 250/239

(57) ABSTRACT

A method and package for packaging an image sensor die utilizes a substrate having a concave space and an opening to connect the image sensor die with the substrate by SMT method. This method can reduce the manufacturing process of packaging the image sensor. The packaging method comprises providing a wafer having a plurality of image sensors, sawing the wafer to form a plurality of dies with a single image sensor, electrically connecting the die having the image sensor with a substrate, the substrate comprising a concave space and an opening, a plurality of solder pads disposed in the concave space for electrically connecting the die having an image sensor, and a plurality of input/output solder pads on the same side of the substrate for connecting to an external element, and filling a transparent adhesive into the opening of the substrate.

### BACKGROUND OF THE INVENTION

1. Field of the Invention

The present invention relates to a method for packaging an image sensor die and a package thereof. In particular, this invention utilizes a substrate having a concave space and an opening to connect the image sensor with the substrate by SMT.

2. Description of the Related Art

Images sensor is usually used in the digital image products, such as digital still cameras, digital cameras and scanners etc. The image sensor can be divided into the charge coupled device (CCD) image sensor and the complementary metal-oxide-semiconductor (CMOS) image sensor. Traditionally, the packages for the CMOS image sensor have the plastic quad flat package (PQFP) and the ceramic package, for example, a ceramic leadless chip carrier. The characteristic of these packages is to put the image sensor die on a substrate, then package it by a wire bonding method, and seal the image sensor die by a glasses cover to protect the image sensor die.

Taiwan patent TW458,377 discloses a “quid flat leadless package structure for a sensor”, as shown in the FIG. 1. The package includes a chip base 10, a plurality of pins 11, a chip 12, a plurality of bonding wire 13, a molding resin 14 and a cover board 15. On the perimeter of the backside of the chip base 10 there are a plurality of pin bases 16. The plurality of pins 11 are disposed on the perimeter of the chip base 10 that has a proper distance from the chip base 10. The molding resin 14 is disposed on the perimeter above the surface of the plurality of pins 11 and filled between the chip base 10 and the pins 11. The bottom of the pins 11 and the bottom of the pin bases located on the backside of the chip base 10 are disclosed. The chip 12 is pasted on the surface of the chip base 10 and is electrically connected with the pins by bonding wires 13. Then, the cover board is covered on the molding resin 14.

Furthermore, the U.S. patent U.S. Pat. No. 5,523,608 discloses a “solid state imaging device having a solid state image sensor and its peripheral IC mounted on one package”, as shown in the FIG. 2. A peripheral IC 20 for a solid state imaging devices is mounted on an island 21 of a lead frame and therefore covered and sealed by a molding resin, thus, forming a premolded package 22. Subsequently, a solid state image sensor 23 is mounted on the island 21 on one side thereof facing an opening. Thereafter, for protection of the solid state image sensor 23, a transparent lid 24 is attached to the premolded package 22 by adhesive, and the solid state image sensor 23 is conducted to the pins 26 via a plurality of bolding wires 25.

However, the described package methods for image sensors needs a wire bonding process and needs a transparent lid to protect the image sensor. The manufacturing process is complex.

### SUMMARY OF THE INVENTION

One particular aspect of the present invention is to provide a method for packaging an image sensor die and a package thereof. The present invention utilizes a substrate having a concave space and an opening to connect the image sensor with the substrate by SMT. It simplifies the manufacturing process for packaging the image sensor.

Another particular aspect of the present invention is to provide a method for packaging an image sensor die and a package thereof. The present invention provides a substrate. The solder pads used for connecting the image sensor with the print circuit board (PCB) are located at the same side of the substrate. Therefore, the image sensor can be connected with the substrate by a SMT, and then also is connected with an external element by SMT.

Further particular aspect of the present invention is to provide a method for packaging an image sensor die and a package thereof. There is an opening on the substrate that corresponds to the sensing area of the image sensor die. The side wall of the opening has a slope. It is contributive for injecting the transparent adhesive into the opening to form a transparent layer for protecting the image sensor die. The method and structure can utilize the SMT to connect the image sensor die with the substrate. Therefore, the manufacturing process for packaging the image sensor die is simplified.

The present invention provides a method for packaging the image sensor die. Firstly, the method provides a wafer. The wafer has a plurality of image sensors. Then, the wafer is sawed into a plurality of dies. Each die has a single image sensor. The die having the image sensor is electrically connected with a substrate. The substrate has a concave space and an opening. On the concave space there are a plurality of solder pads used for electrically connecting to the die having the image sensor. On the substrate there are a plurality of I/O solder pads for connecting to the external element. Finally, the transparent adhesive is filled into the opening of the substrate.

The present invention also provides an image sensor die package structure. The image sensor die package structure includes a substrate having a concave space and an opening, a die having the image sensor, and a transparent adhesive. In the concave space of the substrate there are a plurality of solder pads. The die is located in the concave space of the substrate and is electrically connected with the substrate via the plurality of solder pads. The transparent adhesive is located in the concave space of the substrate.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of an image sensor die package structure of the prior art;

FIG. 2 is a schematic diagram of an image sensor die package structure of another prior art;

FIG. 3A˜3F are schematic diagrams of the method for packaging the image sensor die of the present invention;

FIG. 4 is a schematic diagram of an image sensor die package structure of the present invention;

FIG. 5A is a side view of the substrate of the image sensor die package of the present invention; and

FIG. 5B is a top view of the substrate of the image sensor die package of the present invention.

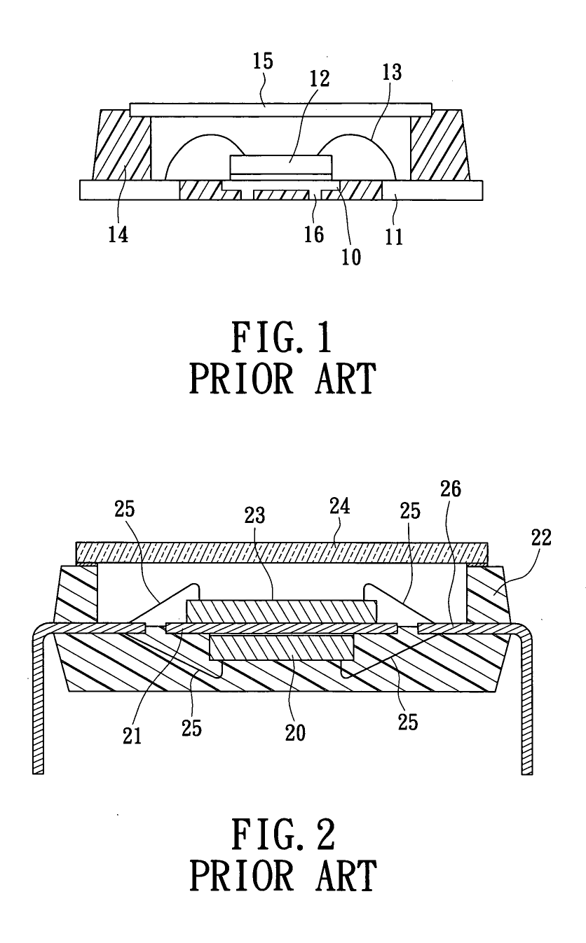

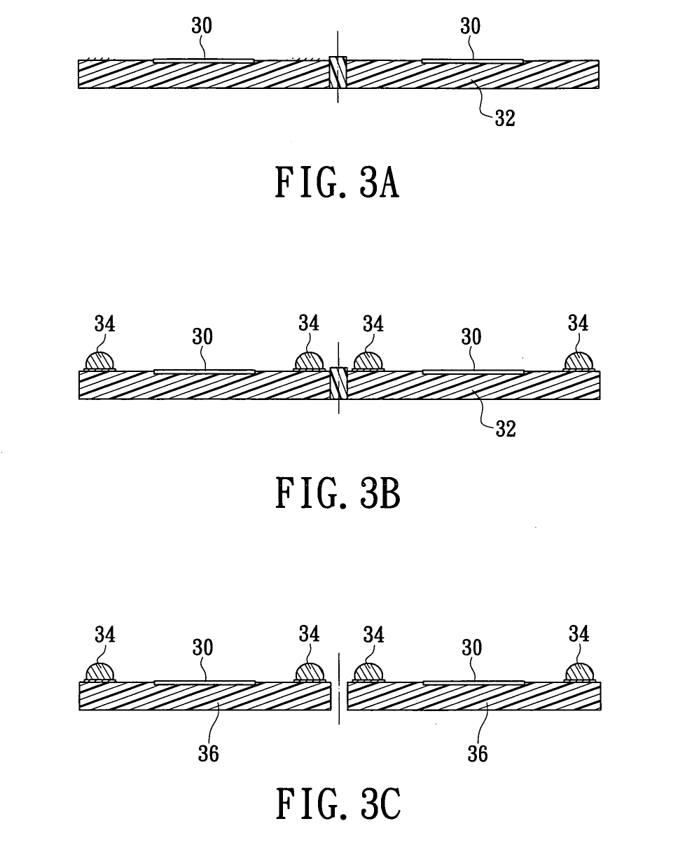

### DETAILED DESCRIPTION OF THE PREFERRED EMBODIMENTS

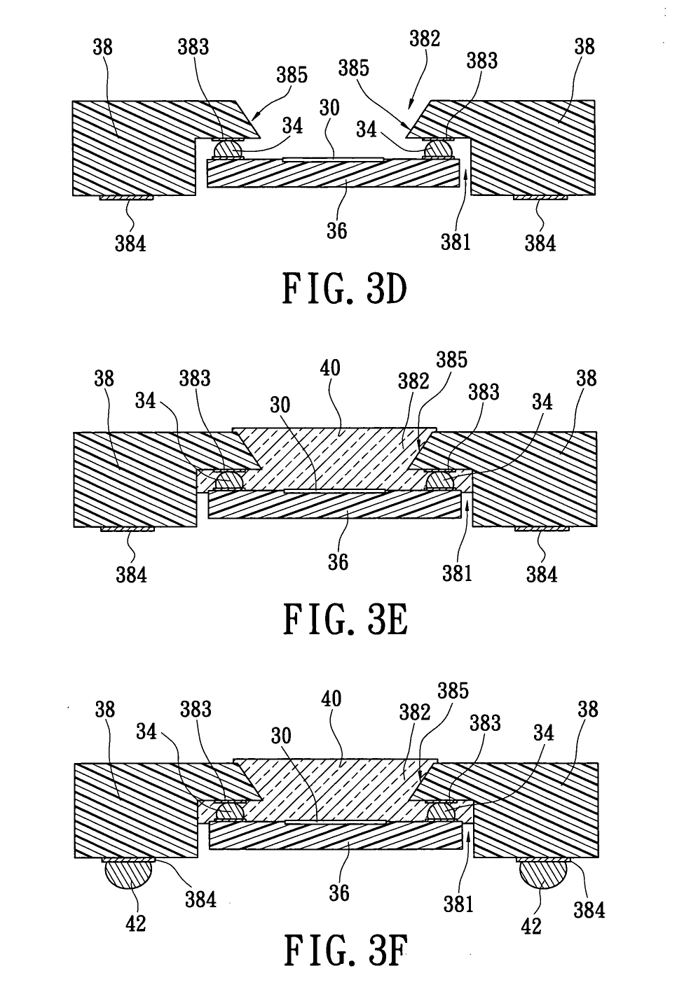

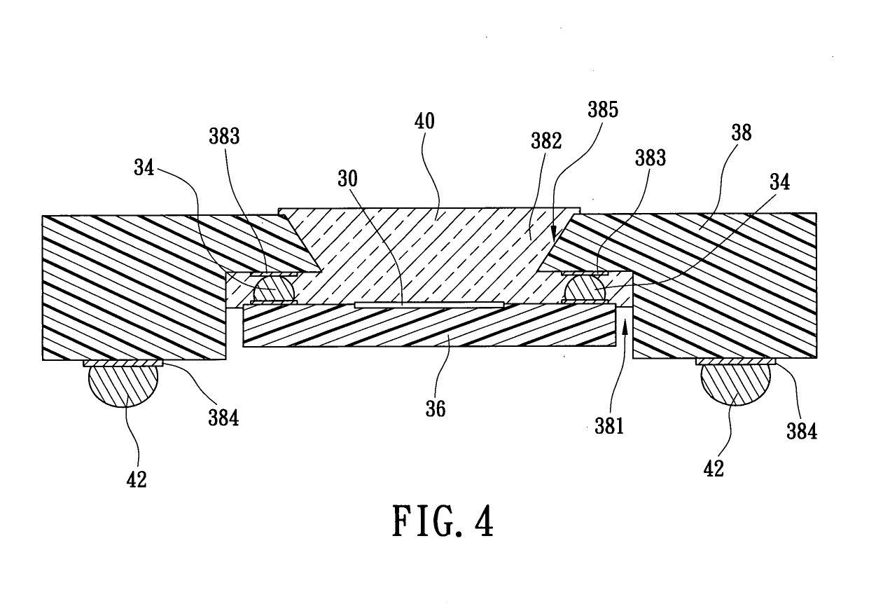

Please refer to FIGS. 3A˜3F, which show schematic diagrams of the method for packaging the image sensor die of the present invention.

The method for packaging the image sensor die of the present invention is used to package a wafer 32 including image sensors 30. The image sensor 30 is a CMOS image sensor. Firstly, a wafer 32 is provided. The wafer 32 includes a plurality of image sensors 30, as shown in FIG. 3A. A plurality of bumps 34 are formed by bumping process on the wafer 32 having plurality of image sensors 30, as shown in FIG. 3B. Then, the wafer 32 having plurality of image sensors 30 is sawed by a sawing process into a plurality of dies 36. Each die 36 includes a single image sensor 30, as shown in FIG. 3C.

The die 36 having an image sensor 30 is electrically connected with a substrate 38, as shown in FIG. 3D. The substrate 38 has a concave space 381 and an opening 382. A plurality of solder pads 383 are located in the concave space 381 for electrically connecting with the die 36 having an image sensor 30. Furthermore, a plurality of I/O solder pads 384 are formed on the same side for connecting with an external element (such as a print circuit board-PCB, not shown in the figure). The opening 382 of the substrate 38 corresponds to the sensing area of the image sensor 30. A slope 385 is located on the opening 382 of the substrate 38 for filling the transparent adhesive. The die 36 having an image sensor 30 is electrically connected with the substrate 38 by SMT (Surface Mounted technology). Firstly, the flux is spread on the solder pads 383 of the substrate 38. Then, the solder paste is coated, and the bumps 34 of the die 36 are aligned to the solder pads 383. Finally, heat is added for connecting the die 36 to the substrate 38.

Then, a transparent adhesive 40 is filled into the opening 382 of the substrate 38. For example, the transparent adhesive 40 is filled between the opening 382 of the substrate 38 and the die 36 having the image sensor 30 to form a transparent protection layer, as shown in FIG. 3E. Furthermore, solder balls 42 are added onto the I/O solder pads 384 of the substrate 38. Therefore, the substrate 38 is electrically connected with the external element (such as a PCB) via the solder balls by SMT.

The present invention also provides an image sensor die package structure, as shown in FIG. 3D. The image sensor die package structure includes a substrate 38 having a concave space 381 and an opening 382. In the concave space 381 of the substrate 38 there are a plurality of solder pads 383. A die 36 having the image sensor 36 is located in the concave space 381 of the substrate 38 and is electrically connected with the bumps 34 of the substrate 38 via the plurality of solder pads 383. Furthermore, a transparent adhesive 40 is filled into the opening 382 of the substrate 38 to form a protection layer. The transparent adhesive 40 is located between the opening 382 of the substrate 38 and the die 36 having the image sensor 30.

The opening 382 of the substrate 38 corresponds to the sensing area of the image sensor 30, and a slope 385 is located on the opening 382 of the substrate 38 for filling the transparent adhesive 40. The substrate 38 further includes a plurality of I/O solder pads 384 and bumps 42 for electrically connecting with an external element (such as a PCB, not shown in the figure) 38 by SMT. The die 36 having the image sensor 30 further comprises a plurality of bumps 34 for electrically connecting with the substrate 38 by SMT. The solder pads 383 and the I/O solder pads 384 are located on the same side of the substrate 38.

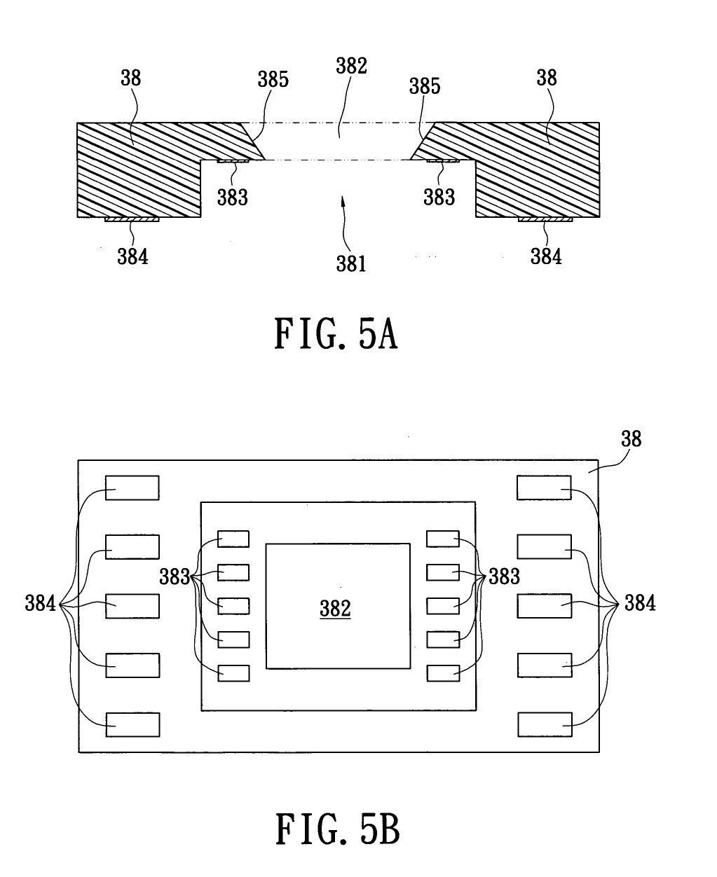

FIG. 5A shows a side view of the substrate of the image sensor die package of the present invention, and FIG. 5B shows a top view of the substrate of the image sensor die package of the present invention. By FIGS. 5A and 5B, the structure of the substrate of the image sensor die package of the present invention is understood more clearly. The substrate 38 has a concave space 381 and an opening 382. The dimension of the concave space 381 of the substrate 38 is determined according to the dimension of the die for receiving the die. The thickness of the substrate is determined according to the thickness of the die to enhance the strength of the substrate. The slope 385 is located on the opening 382 of the substrate 38 for filling the transparent adhesive 40, and in the concave space 381 of the substrate 38 there are a plurality of solder pads 383. Moreover, the substrate 38 further includes a plurality of I/O solder pads 384, and the solder pads 383 and the I/O solder pads 384 are located on the same side of the substrate 38. Thereby, the method for packaging the image sensor die of the present invention can simplify the manufacturing process by using the described substrate.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An image sensor die package structure, comprising:
a substrate having a concave space and an opening; wherein in the concave space of the substrate has a plurality of solder pads;
a die having image sensor that is located in the concave space and is electrically connected with the substrate via the solder pads; wherein the die having image sensor further comprises a plurality of bumps for electrically connecting with substrate; and
a transparent adhesive located in the opening of the substrate;
wherein the opening of the substrate corresponds to the sensing area of the image sensor, and the plurality of solder pads and the plurality of I/O solder pads are located at the same side of the substrate.

2. The image sensor die package structure as claimed in claim 1, wherein the opening of the substrate has a slope for filling the transparent adhesive.

3. The image sensor die package structure as claimed in claim 1, wherein the substrate further comprises a plurality of I/O solder pads for electrically connecting with an external element.

4. The image sensor die package structure as claimed in claim 1, wherein the substrate further comprises a plurality of bumps for electrically connecting with an external element.
